(19) United States
(12) Patent Application Publication
(10) Pub. No.: US 2010/0161166 A1
(43) Pub. Date: Jun. 24, 2010

(54) Drive control apparatus for hybrid vehicle, travel schedule making apparatus for hybrid vehicle and travel route prediction apparatus

(75) Inventors: Kazunao Yamada, Toyota-city (JP); Yusuke Mizuno, Anjo-city (JP); Tadashi Sakai, Obu-city (JP)

Correspondence Address: HARNESS, DICKEY & PIERCE, P.L.C., P.O. BOX 828, BLOOMFIELD HILLS, MI, 48303, US

(73) Assignee: DENSO CORPORATION, Kariya-City (JP)

(21) Appl. No.: 12/653,663

(22) Filed: Dec. 16, 2009

(30) Foreign Application Priority Data
Dec. 19, 2008 (JP) 2008-323603

(51) Int. Cl. G06F 19/00; B60W 10/04; B60W 20/00

(52) U.S. Cl. 701/22; 180/65.265

(57) ABSTRACT

A drive control apparatus for a hybrid vehicle is disclosed. The apparatus is configured to: record, for every section of a traveled route, a number of times the hybrid vehicle has traveled the section; identify subsequent sections, which the hybrid vehicle is expected to travel after a present position section; calculate, for every subsequent section, a travel probability that the hybrid vehicle travels the subsequent section, based on the number of times; determine a high reliable section based on the travel probability; and perform the drive control of the internal combustion engine and the motor based on the travel schedule when it is determined that the hybrid vehicle has moved into the high reliable section, the travel schedule being made through setting a planned section to the high reliable section.

### CROSS REFERENCE TO RELATED APPLICATION

The present application is based on Japanese Patent Application No. 2008-323603 filed on Dec. 19, 2008, disclosure of which is incorporated herein by reference.

### BACKGROUND OF THE INVENTION

1. Field of the Invention

The present invention relates to a drive control apparatus and a travel schedule making apparatus for a hybrid vehicle to enable drive control of an internal combustion engine and a motor based on a travel schedule. The present invention also relates to a travel route prediction apparatus for a vehicle.

2. Description of Related Art

A hybrid vehicle uses an internal combustion engine and a motor as a power source for traveling. JP-2000-333305A corresponding to U.S. Pat. No. 6,314,347 discloses an apparatus mounted to a hybrid vehicle to perform drive control of an internal combustion engine and a motor of the hybrid vehicle. The apparatus accumulatively records information on a traveled route that the hybrid vehicle has traveled, estimates a destination point based on the information on a traveled route, retrieves an optimum route from a departure point to the destination point, makes a travel schedule by using the optimum route as a planned section, and performs the drive control of the internal combustion engine and the motor based on the travel schedule.

The apparatus disclosed in JP-2000-333305A corresponding to U.S. Pat. No. 6,314,347 retrieves an optimum route based on the stored information on a traveled route, and makes a travel schedule by using the optimum route as a planned section. The inventors of the present application have found that a conventional technique involves the following difficulties. According to a conventional technique, even when the optimum route includes a section which the vehicle travels with a low probability and another section which the vehicle travels with a high probability, the travel schedule is made by using such optimum route as a planned section regardless of the travel probability in sections of the optimum route.

When the drive control of the engine and the motor is performed based on the travel schedule made in the above-described way, it is highly probable that the hybrid vehicle deviates from the planned section, because the planned section can include a section that the vehicle travels with a low probability. In such a case, because the travel schedule may be repeatedly re-scheduled, fuel efficiency may be lowered.

When the above conventional technique is applied to a travel route prediction apparatus for predicting a travel route of a vehicle, the travel route prediction apparatus may predict a travel route that includes a section that the vehicle travels with a low probability. Therefore, it is highly probable that the vehicle deviates from the predicted travel route.

### SUMMARY OF THE INVENTION

In view of the above and other difficulties, it is an objective of the present invention to provide a technique that can improve fuel efficiency of a hybrid vehicle in which the drive control of an internal combustion and a motor of the hybrid vehicle is performed based on a travel schedule. It is also an objective of the present invention to provide a technique that can more precisely predict a travel route of a vehicle.

According to a first aspect of the present disclosure, there is provided a drive control apparatus (i) mounted to a hybrid vehicle using an internal combustion engine and a motor as a power source for traveling, (ii) configured to perform drive control of the internal combustion engine and the motor of the hybrid vehicle based on a travel schedule, and (iii) coupled with a storage medium. The drive control apparatus is configured to: accumulatively record information on a plurality of sections of a traveled route that the hybrid vehicle has traveled; accumulatively record, for every section of the traveled route, a number of times the hybrid vehicle has traveled the section; identify a present position section and a plurality of subsequent sections from the sections of the traveled route, wherein the present position section is where the hybrid vehicle is located, wherein the subsequent sections include the present position section and another section where the hybrid vehicle is expected to travel after the present position section; calculate, for every subsequent section, a travel probability, that the hybrid vehicle travels the subsequent section, based on the number of times; and record a high reliable section in the storage medium through setting the high reliable section to a series of continuous sections included in the subsequent sections, wherein each section in the series of continuous sections has the travel probability that is greater than or equal to a threshold. The drive control apparatus is further configured to: determine whether the hybrid vehicle has moved into the high reliable section stored in the storage medium; and perform the drive control of the internal combustion engine and the motor based on the travel schedule when it is determined that the hybrid vehicle has moved into the high reliable section, the travel schedule being made by using the high reliable section as a planned section.

According to the above drive control apparatus, a section which the hybrid vehicle travels with a low travel probability is excluded from the high reliable section, and a section which the hybrid vehicle travels with a high travel probability constitutes the high reliable section. Since the travel schedule is made by using such high reliable section as the planned section, and since the drive control of the internal combustion engine and the motor is performed based on the travel schedule, it is possible to improve fuel efficiency of the hybrid vehicle.

According to a second aspect of the present disclosure, there is provided a travel schedule making apparatus mounted to a hybrid vehicle, which uses an internal combustion engine and a motor as a power source for traveling and is configured to perform drive control of the internal combustion engine and the motor based on a travel schedule. The travel schedule making apparatus is coupled with a storage medium. The travel schedule making apparatus is configured to: accumulatively record information on a plurality of sections of a traveled route that the hybrid vehicle has traveled; accumulatively record, for every section of the traveled route, a number of times the hybrid vehicle has traveled the section; identify a present position section and a plurality of subsequent sections from the sections of the traveled route, wherein the present position section is where the hybrid vehicle is located, wherein the subsequent sections include the present, position section and another section where the hybrid vehicle is expected to travel after the present position section; calculate, for every subsequent section, a travel probability that the hybrid vehicle travels the subsequent section after the present position section, based on the number of times; and record a high reliable section in the storage medium through setting the high reliable section to a series of continuous sections included in the subsequent sections, wherein each section in the series of continuous sections has the travel probability that is greater than or equal to a threshold. The travel schedule making apparatus is further configured to make the travel schedule through setting a planned section to the high reliable section stored in the storage medium.

According to the above travel schedule making apparatus, a section which the hybrid vehicle travels with a low travel probability is excluded from the high reliable section, and a section which the hybrid vehicle travels with a high travel probability constitutes the high reliable section. Since the travel schedule is made by using such high reliable section as the planned section, and since the drive control of the internal combustion engine and the motor can be performed based on the travel schedule, it becomes possible to improve fuel efficiency of the hybrid vehicle.

According to a third aspect of the present disclosure, there is provide a travel route prediction apparatus (i) mounted to a vehicle, (ii) configured to predict a expected travel route that the vehicle is expected to travel, and (iii) coupled with a storage medium. The travel route prediction apparatus is configured to: accumulatively record information on a plurality of sections of a traveled route that the hybrid vehicle has traveled; accumulatively record, for every section of the traveled route, a number of times the hybrid vehicle has traveled the section; identify a present position section and a plurality of subsequent sections from the sections of the traveled route, wherein the present position section is where the hybrid vehicle is located, wherein the subsequent sections include the present position section and another section where the hybrid vehicle is expected to travel after the present position section; calculate, for every subsequent section, a travel probability that the hybrid vehicle travels the subsequent section, based on the number of times; and record a high reliable section in the storage medium through setting the high reliable section to a series of continuous sections included in the subsequent sections, wherein each section in the series of continuous sections has the travel probability that is greater than or equal to a threshold. The travel route prediction apparatus is further configured to predict the expected travel route by setting the expected travel route to the high reliable section stored in the storage medium.

According to the above travel route prediction apparatus, a section which the vehicle travels with a low travel probability is excluded from the high reliable section, and a section which the vehicle travels with a high travel probability constitutes the high reliable section. Since the expected travel route becomes such high reliable section stored in the storage medium, it is possible to more precisely predict a travel route of a vehicle.

### BRIEF DESCRIPTION OF THE DRAWINGS

The above and other objects, features and advantages of the present invention will become more apparent from the following detailed description made with reference to the accompanying drawings. In the drawings:

FIG. 1 is a diagram illustrating a drive control apparatus for a hybrid vehicle according to one embodiment;

FIG. 2 is a flowchart illustrating a high reliable section record procedure;

FIGS. 3A to 3C are diagrams each illustrating probabilities of traveling subsequent sections, which a vehicle is expected to travel after a present position section;

FIG. 4 is a diagram illustrating a series of scheduled sections and a length of the series;

FIG. 5 is a flowchart illustrating a schedule planning process;

FIG. 6 is a diagram illustrating high reliable sections that are stored on a destination-by-destination basis;

FIG. 7 is a flowchart illustrating a warm-up section record procedure;

FIG. 8 is a diagram illustrating a warm-up section;

FIG. 9 is a flowchart illustrating a drive control procedure;

FIG. 10 is a diagram illustrating a high reliable section; and

FIG. 11 is a flowchart illustrating a drive control procedure according to a modification example.

### DETAILED DESCRIPTION OF THE EXEMPLARY EMBODIMENTS

The exemplary embodiments are described below with reference to the accompanying drawings.

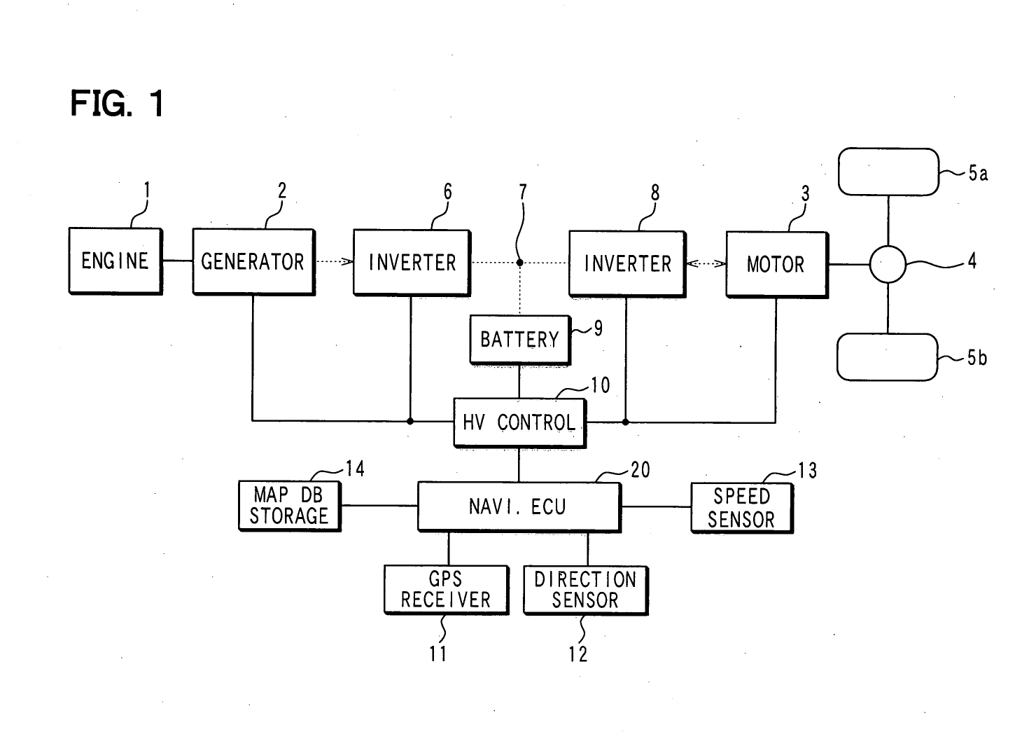

FIG. 1 schematically illustrates a drive control apparatus for a hybrid vehicle (HV) in accordance with one embodiment. The hybrid vehicle is equipped with an internal combustion engine 1, an electric generator 2, a motor 3, a differential device 4, tires 5a and 5b, an inverter 6, a direct current (DC) link 7, a battery 9, a HV controller 10, a global positioning system (GPS) receiver 11, a direction sensor 12, a vehicle speed sensor 13, a map database (DB) storage 14 and a navigation electronic control unit (ECU) 20.

The hybrid vehicle travels uses the engine 1 and the motor 3 as a power source. When the engine 1 is serving as the power source, torque of the engine 1 is transmitted to the tires 5a and 5b via a clutch mechanism (not shown) and the differential device 4. When the motor is serving as the power source, a DC power of the battery 9 is converted into an AC power through the DC link 7 and the inverter 8, and the motor 3 operates by the AC power and generates torque, which is transmitted to the tires 5a and 5b via the differential device 4. In the present disclosure, an engine travel mode may refer to a mode where only the engine 1 serves as the power source. An assist travel mode may refer to a mode where the motor 3 serves as the power source. In the assist travel mode, in addition to the motor 3, the engine 1 also may serve as the power source.

The torque of the engine 1 is also transmitted to the generator 2 so that the generator 2 generates AC power, which is converted into DC power through the inverter 6 and the DC link 7, and the DC power is stored in the battery 9. The electric charging of the battery 9 in the above manner results from operation of the engine 1 using fuel and may be also referred to hereinafter as a combustional charging.

When the hybrid vehicle decelerates due to operation of a brake mechanism (not shown) or the like for instance, a resistance force in the decelerating is applied to the motor 3 in the form of torque, and the motor 3 generates AC power using the applied torque. The generated AC power is converted into DC power through the inverter 8 and the DC link 7, and the DC power is stored in the battery 9. The charging of the battery in the above manner may be referred to hereinafter as a regenerative charging.

The HV controller 10 controls execution and non-execution of the above and other operations of the generator 2, the motor 3, the inverters 6 and 8, the battery 9 and the like based on an instruction signal from the navigation ECU 20 or the like. The HV controller 10 may include a general-purpose microcomputer and/or hardware having a dedicated circuit realizing the below-described functions.

For example, the HV controller 10 stores therein a value associated with a present SOC (state of charge) and a value associated with a reference SOC. The value associated with the present SOC may be also referred to as a present SOC value, and the value associated with the reference SOC may be also referred to as a reference SOC value. The HV controller 10 performs the following operations “A” and “B”. In the operation “A”, the HV controller 10 changes the reference DOC value based on a control target value that may be a scheduled SOC inputted from the navigation ECU 20, and controls actuators such as the generator 2, the motor 3, the inverter 6, the inverter 8, the battery 9 and the like. In the operation “B”, the HV controller 10 periodically informs the navigation ECU 20 of the present SOC.

The SOC (State of charge) is an indicator of a remaining battery level. The SOC value becomes larger value as the remaining battery level becomes larger. The present SOC indicates the present-time SOC of the battery 9. The HV controller 10 cyclically updates the present SOC value by cyclically detecting the state of the battery 9. The reference SOC is a control target value (e.g., 60 percent) of the remaining battery level. The HV controller 10 can use the reference SOC to make a determination regarding electric generation/assistance. The reference SOC value can be changed under control of the navigation ECU 20.

The HV controller 10 controls switching the travel mode of the hybrid vehicle between the engine travel mode and the assist travel mode based on the control target value inputted from the navigation ECU 20. Further, the HV controller 10 controls switching the combustional charging between ON (execution) and OFF (non-execution), and controls switching the regenerative charging between ON (execution) and OFF (non-execution). In one embodiment, the control target value is a scheduled SOC. The HV controller 10 determines a driving manner and controls the actuators based on the determined travel manner so that the present SOC is maintained at or around the scheduled SOC.

The HV controller 10 receives various signal including: a signal (not shown) indicating whether engine coolant temperature is higher than or equal to a threshold; and a signal (not shown) indicating whether temperature of a catalyst in an exhaust gas purification apparatus is higher than or equal to a threshold. Based on the above signals, the HV controller 10 determines whether the warming up is to be performed. When it is determined that the warming up is to be performed, the HV controller 10 outputs to the navigation ECU 20 a warm-up determination information indicating that the warming-up is to be performed. The warm-up determination information may be in the form of digital signal whose value is O or 1.

The GPS receiver 11, the direction sensor 12 and the vehicle speed sensor 13 are used to specify location, heading direction and traveling speed of the hybrid vehicle, and may be known sensors. The map DB storage 14 includes a storage medium storing therein map data

The map data includes data for nodes corresponding to intersections, data for links corresponding to road sections, which connect intersections. Data for each node includes information on an identifier (e.g., identification number) of the node, information on location of the node, and information on type of the node. Data for each link includes information on an identifier of the link (e.g., link ID), information on length of the section, information on location of the section, and information on type of the section.

The navigation ECU 20 may be configured as a microcomputer including the following components (not, shown): a RAM; ROM; a rewritable information retainable storage; and CPU. The information retainable storage may be a storage medium that can retain stored data without loss even if supply of main power source of the navigation ECU 20 is cut. The information retainable storage may be a non-volatile storage medium (e.g., a hard disk drive, a flash memory, an EEPROM), a backup RAM or the like.

The CPU of the navigation ECU 20 performs various procedures based on programs stored in the information retainable storage or the ROM. The procedures performed by the navigation ECU 20 include a position location procedure, a map matching procedure, a route calculation procedure and a navigation procedure. In the position location procedure, the navigation ECU 20 specifies the present location of the subject vehicle based on location information obtained from the GPS receiver 11, the direction sensor 12 and the vehicle speed sensor 13. In the map matching procedure, the navigation ECU 20 specifies which road the subject vehicle is located on with respect to a map stored in the map DB storage 14. In the route calculation procedure, the navigation ECU 20 searches for and determines an optimum travel route to a destination. In the navigation procedure, the navigation ECU 20 performs a route guide operation along the travel route to the destination.

In one embodiment, the navigation ECU 20 further performs a high reliable section record procedure, a warm-up section record procedure and a drive control procedure by using travel information, which is associated with sections of a traveled route that the subject vehicle has traveled. In the high reliable section record procedure: the navigation ECU 20 accumulatively records, for every section of the traveled route, a number of times the vehicle has traveled the section; the navigation ECU 20 identifies a present position section, which the vehicle is located in; the navigation ECU 20 identifies subsequent sections, which the vehicle is expected to travel after the present position section; the navigation ECU 20 calculates, for every subsequent section, a travel probability that the vehicle travels the subsequent section after the present position section, based on the number of times; the navigation ECU 20 sets a high reliable section to a series of continuous sections included in the subsequent sections, wherein each section in the series of continuous sections has the travel probability that is greater than or equal to a threshold; the navigation ECU 20 records the high reliable-section in the information retainable storage; and the navigation ECU 20 makes a control schedule (which corresponds to travel schedule) by using the high-reliable section as a planned section. In the warm-up section record procedure, the navigation ECU 20 records or updates warm-up information stored in the information retainable storage. The warm-up information indicates whether each of the sections of the traveled route corresponds to a warm-up section where the warming up has been performed. In the drive control procedure, the drive control of the engine and the motor is preformed based on the travel schedule, which was made by using the high reliable section stored in the information retainable storage as the planned section.

In the followings, there will be more specifically described the high reliable section record procedure, a warm-up section record procedure and a drive control procedure.

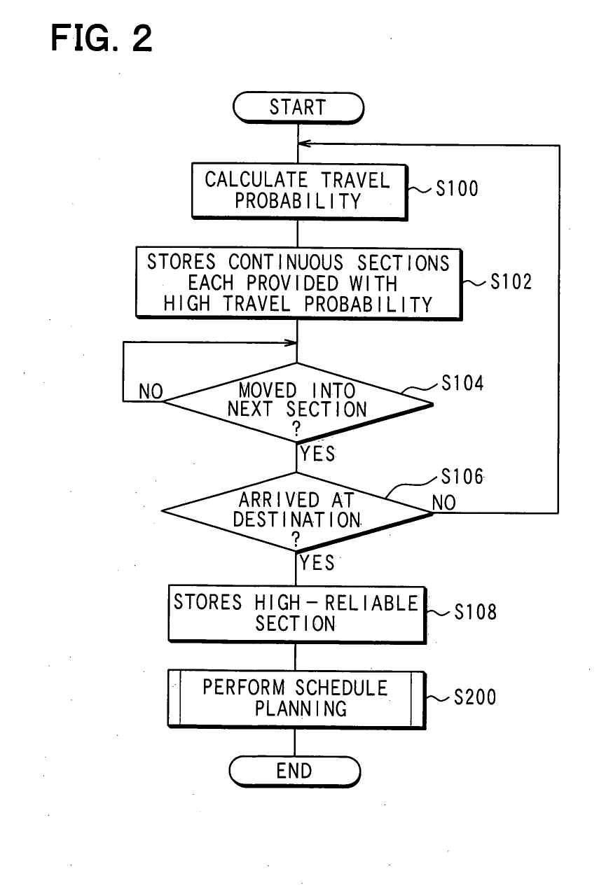

The reliable section record procedure is explained below with reference to FIG. 2. When an ignition switch of the hybrid vehicle is turned on, a drive control apparatus of the hybrid vehicle starts operating, and the navigation ECU 20 performs the reliable section record procedure illustrated in FIG. 2.

Until it is determined at S106 that the subject vehicle has arrived at the destination, the navigation ECU 20 cyclically performs S100 and S102 every time it is determined at S104 that the subject vehicle has moved into a next section, which is a section next to the present position section. In one embodiment, the navigation ECU 20 can receive a signal indicating that a parking brake is in an ON state. When receiving the signal indicating that the parking brake is in the ON state, the navigation ECU 20 determines at S106 that the subject vehicle has arrived at the destination. At S104, the navigation ECU 20 reads data of a map around the present location of the subject vehicle from the map DB storage 14, and determines whether the subject vehicle has moved into a next section by determining whether the present location is in the nest section.

At S100, for every section of the traveled route (which the subject vehicle has traveled ever), the navigation ECU 20 accumulatively records the number of times the subject vehicle has traveled the section. Further, for every subsequent section, the navigation ECU 20 calculates a travel probability that the subject vehicle travels the subsequent section after a present position section, based on the number of times. In the above, the present position section is where the subject vehicle is presently located, and a subsequent section is where the subject vehicle is expected to travel after the present position section. In one embodiment, the subsequent section is regarded as a sum of the present position section and a section that the subject vehicle is expected to travel after the present position. Further, the navigation ECU, 20 calculates the travel probability based on the number of times that has been accumulated for a predetermined period of time, which may be between the present time and a month ago for instance. Further,

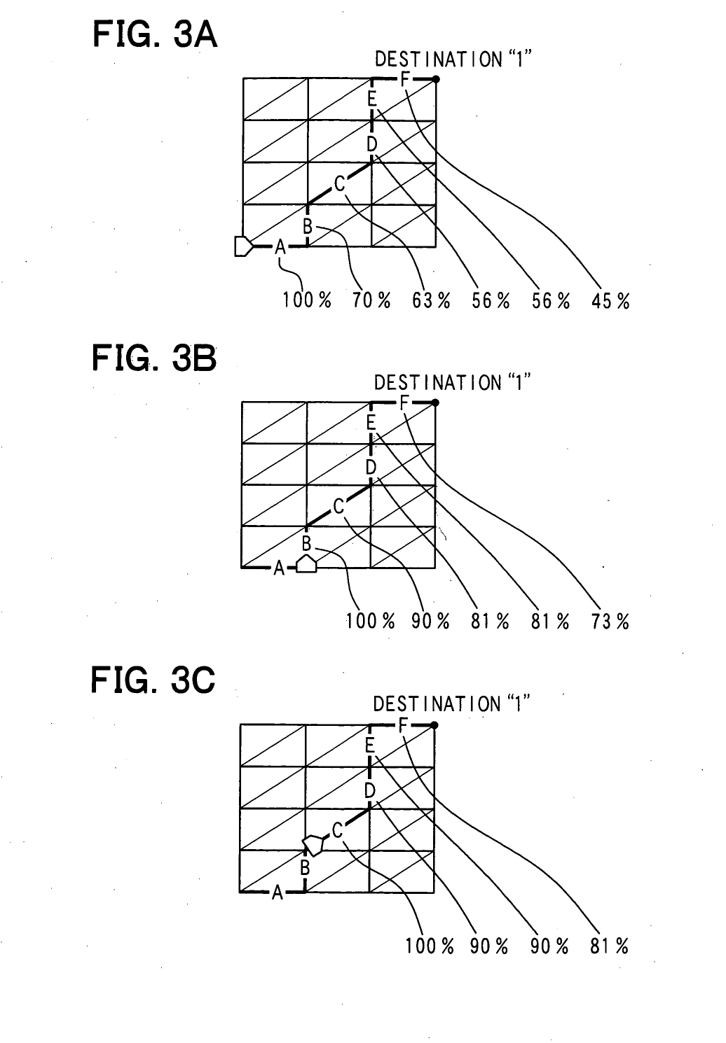

In a case illustrated in FIG. 3A, the subject vehicle is located in a section “A”, and the navigation ECU 20 calculates at S100 travel probabilities for respective subsequent sections, which the subject vehicle is expected to travel after the present position section “A”. In this case, the travel probability for the section “A” is 100%, the travel probability for a subsequent section “B” is 90%, the travel probability for a subsequent section “C” is 63%, the travel probability for a subsequent section “D” is 56%, the travel probability for a subsequent section “E” is 56%, and the travel probability for a subsequent section “F” is 45%.

When the subject vehicle is moved into the section “B” as is illustrated in FIG. 3B, the navigation ECU 20 calculates at S100 travel probabilities for respective subsequent sections such that the travel probability for the section “B” is 100%, the travel probability for the subsequent section “C” is 90%, the travel probability for the subsequent section “D” is 81%, the travel probability for the subsequent section “E” is 81%, and the travel probability for the subsequent section “F” is 73%.

When the subject vehicle is moved into the section “C” as is illustrated in FIG. 3C, the navigation ECU 20 calculates at S100 travel probabilities for respective subsequent sections, such that the travel probability for the section “C” is 100%, the travel probability for the subsequent section “D” is 90%, the travel probability for the subsequent section “E” is 90%, and the travel probability for the subsequent section “F” is 81%.

At S102, the navigation ECU 20 identifies a series of continuous sections included in the subsequent sections, wherein each section of the series of continuous sections has a travel probability that is greater than or equal to a predetermined threshold. Further, the navigation ECU 20 records the identified series of continuous sections as a series of scheduled sections. The series of scheduled sections may be simply referred to herein as a scheduled section. In one embodiment, the predetermined threshold may be set to 80%, and the navigation ECU 20 extracts, from the subsequent sections, a series of continuous sections each provided the travel probability of 80% or more. The extracted series of continuous sections are stored in the information retainable storage as a series of scheduled sections. Further, a total length of the series of scheduled sections is stored in the information retainable storage.

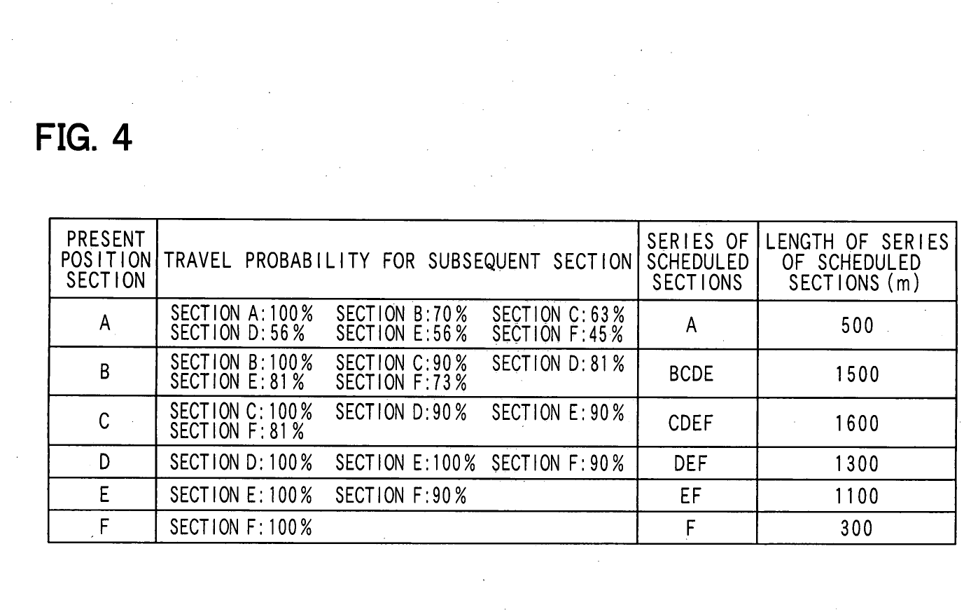

In a case illustrated in FIG. 4, the predetermined threshold is 80%, and a length of each section is as follows: the section “A” has 500 meters long; the section “B” has 200 meters long; the section “C” has 300 meters long; the section “D” has 200 meters long; the section “E” has 800 meters long; and the section “F” has 300 meters long. In a case illustrated in FIG. 4, when the subject vehicle is in the section “A”, a series of scheduled sections is the section “A”, a length of the series is 500 meters. When the subject vehicle is presently in the section “B”, the series of scheduled sections is sections “B”, “C”, “D” and “E”, and a length of the series is 1500 meters. When the subject vehicle is presently in the section “C”, the series of scheduled sections is sections “C”, “D”, “E” and “F”, and a length of the series is 1600 meters. When the subject vehicle is presently in the section “F”, the series of scheduled sections is sections “F”, and a length of the series is 300 meters. It should be noted, when the series of scheduled sections is stored in the information retainable storage, reference numerals (e.g., a link. ID) may be utilized to refer to respective sections of the scheduled sections.

When the subject vehicle has arrived at the destination and when the signal indicating that the parking brake is in the ON state is inputted to the navigation ECU 20, the determination at S106 results in “YES” and the process proceeds to S108. At S108, the navigation ECU 20 selects one series of scheduled sections from a group of series of scheduled sections, so that the selected one series has the largest length among the group of series. In a case of FIG. 4, the group of series can include a series of scheduled sections “B”, C”, “D and “E”, and another series of scheduled sections “C”, “D”, “E” and “F”. At S108, the navigation ECU 20 records the selected series of scheduled sections in the information retainable storage as a high reliable section. For example, in the case illustrated in FIG. 4, since the series of scheduled sections “C”, “D”, “E” and “F” has the largest length of 1600 meters, the series of scheduled sections “C”, “D”, “E” and “F” is stored as a high reliable section.

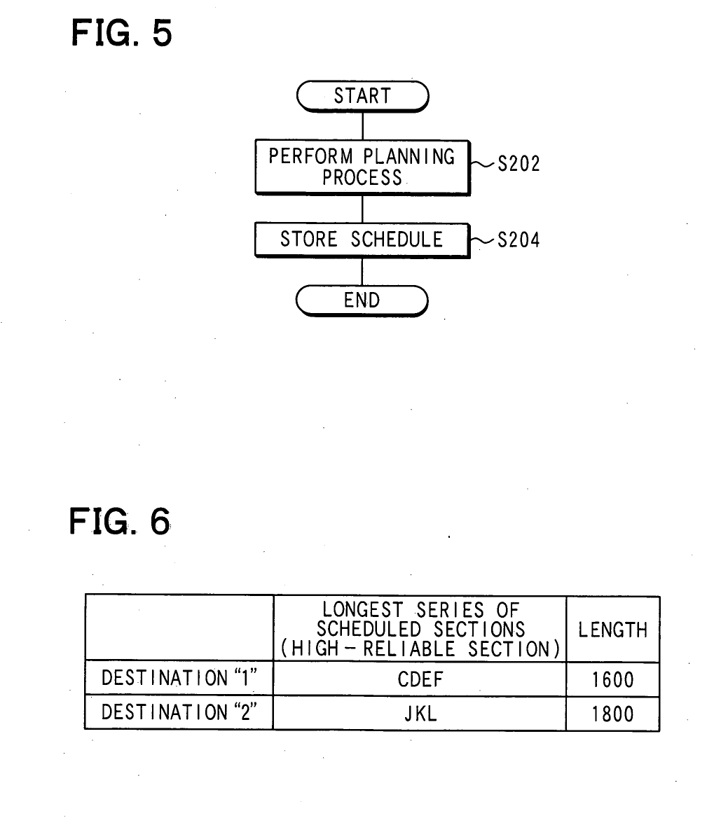

At S200, the navigation ECU 20 performs a schedule planning process, a flowchart of which is illustrated in FIG. 5.

In the schedule planning process, the navigation ECU 20 performs a planning process at S202. More specifically, the series of scheduled sections specified as the high reliable section is set as a planned section. Further, an energy required to travel through the planned section is calculated based on travel information stored in the information retainable storage. The travel manner is determined for each road identifier based on travel information stored in the information retainable storage. For example, the navigation ECU 20 obtains the reference SOC from the HV controller 10. Based on the reference SOC and the travel information (which was recorded when the subject vehicle had traveled from the departure point and the destination point), the navigation ECU 20 calculates an electric power generation efficiency and an assist efficiency for each road identifier associated with the planned section between the departure and the destination, and determines control manners for each road identifier of the planned section. The control manners includes selection of the travel mode from the engine travel mode and the assist travel mode, determination of whether the combustional charging is performed, and determination of whether the regenerative charging is performed. Then, a SOC management schedule for each section is made based on the travel information stored in the information retainable storage. The SOC management schedule predicts transition of the scheduled SOC acting as the control target value till the destination, and is an example of a travel schedule. It is possible to employ a known method as a method of making such SOC management schedule (see. JP-2001-183150A, and Horie (2006) “Development of New Powered Vehicle”, P123 o P124, publisher: CMC publishing, ISBN-10:4882319012, ISBN-13:978-4882319016).

At S204, the navigation ECU 20 records the SOC management schedule in the durable storages medium. Then, the schedule planning process is ended.

Every time the vehicle travels, the navigation ECU 20 performs the reliable section record procedure, thereby specifying the high reliable section, making the SOC management schedule through setting the planed section to the high reliable section, and recording the SOC management schedule.

As shown in FIG. 6, the high reliable sections are classified according to respective destinations, and are separately stored in the information retainable storage together with the SOC management schedules. For example, the high reliable section and the SOC management schedule for travel route to a destination “1” (arrival point), and those for a travel route to a destination “2” are distinctively stored in the information retainable storage.

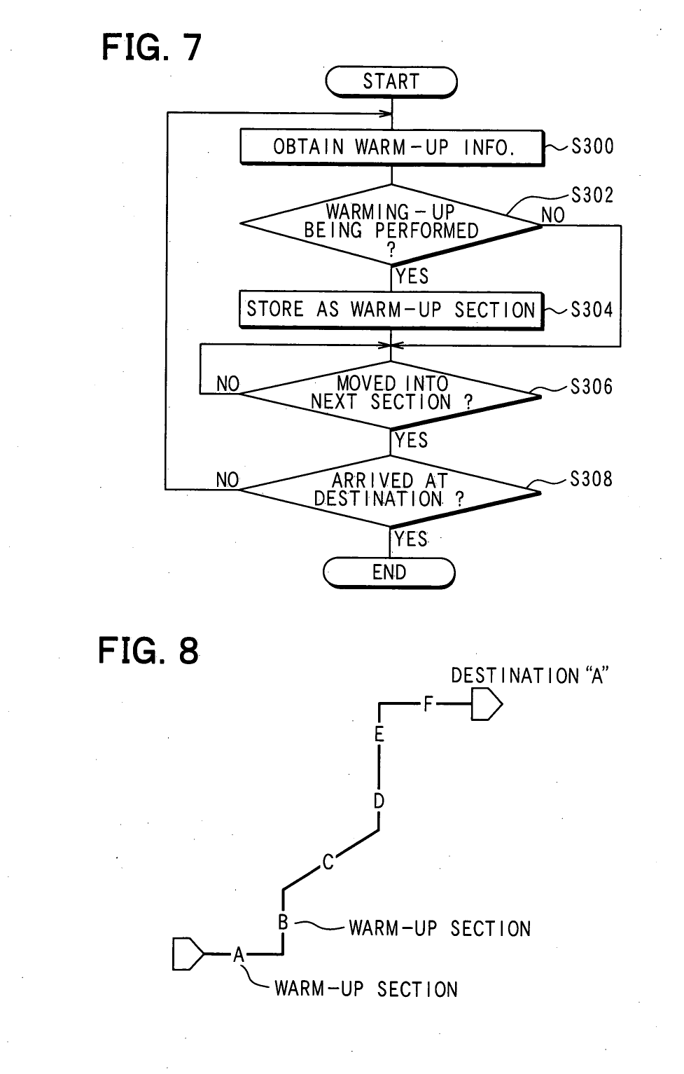

A warm-up section record procedure is explained below with reference to FIG. 7. When the ignition switch of the vehicle is turned on, the navigation ECU 20 performs the warm-up section record procedure illustrated in FIG. 7 in parallel to the high reliable section record procedure illustrated in FIG. 2.

At S300, the navigation ECU 20 obtains the warm-up determination information from the HV controller 10. At S302, the navigation ECU 20 determines whether the warming up is being performed in the vehicle, based on the warm-up determination information.

When it is determined that the warming up is being performed, corresponding to “YES” at S302, the process proceeds to S304. At S304, the present position section is stored as a warm-up section in the information retainable storage. More specifically, a flag may be assigned to each of sections to indicate whether the section is a warm-up section. In the above, the flag may be made to correspond to a reference numeral (e.g., a link ID) for each of the sections. When it is determined that the warming up is being performed, the flag assigned to the present position section is made ON and is accumulatively stored in the information retainable storage. Based on stored information on the flag, the navigation ECU 20 calculates a frequency as to how often the warming up has been performed for a predetermined period of time, which may be between the present time and a month ago. The navigation ECU 20 records the frequency in the information retainable storage, and the process proceeds to S306. In the present disclosure, a frequency as to how often the warming up has been performed in a section for a predetermined period of time may be also referred to as a warm-up frequency.

When it is determined that the warming up is not being performed, corresponding to “NO” at S302, the process proceeds to S306.

At S306, the navigation ECU 20 determines whether the vehicle has moved into the next section by determining whether the present location of the vehicle is in the next section.

When it is determined that the vehicle has not moved into the next section, the navigation ECU 20 repeatedly performs S306 until the vehicle has moved into the next section. When it is determined that the vehicle has moved into the next section, corresponding to “YES” at S306, the process proceeds to S308. At S308, the navigation ECU 20 determines whether the vehicle has arrived at the destination based on determining whether the signal indicating that the parking brake is in the ON state is inputted.

When the signal indicating that the parking brake is in the ON state is not inputted, corresponding to “NO” at S308, the process returns to S300. When the vehicle has arrived at the destination and when the signal indicating that the parking brake is in the ON state is inputted, corresponding to “YES” at S308, the warming up section record procedure is ended.

When the warming up is performed in the sections “A” and “B” as is illustrated in FIG. 8, the flags for the sections “A” and “B” are made ON to indicate that each of the sections “A” and “B” is the warm-up section. Information on the flags for the sections “A” and “B” is stored in the information retainable storage. Further, the frequencies as to how often the warming up has been performed in the sections “A” and “B” for a predetermined period of time is updated and stored in the information retainable storage. In the above, the navigation ECU 20 does not change stored information on flags for sections where the warming up is not being performed.

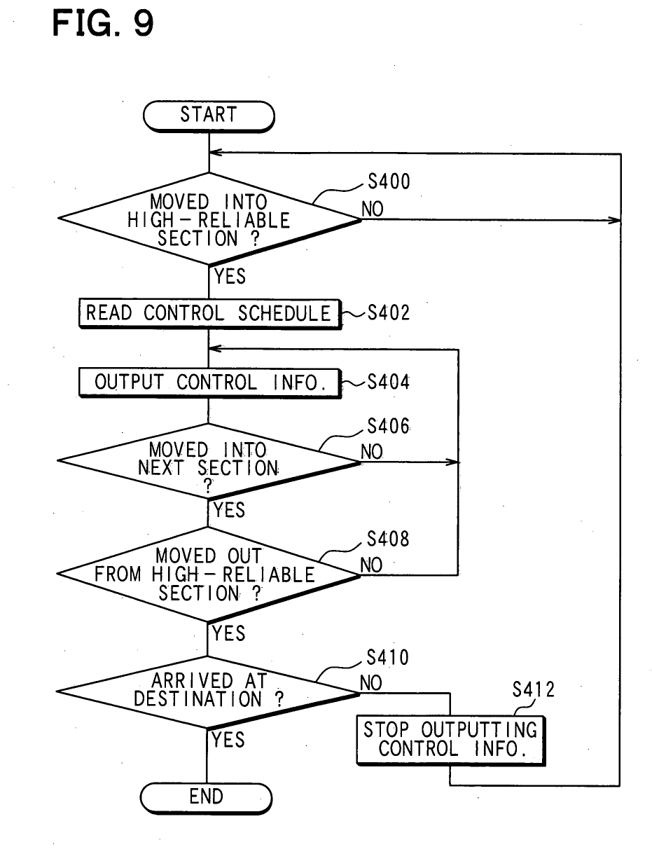

The drive control procedure is explained below with reference to FIG. 9. When the ignition switch of the vehicle is turned on, the navigation ECU 20 performs the drive control procedure illustrated in FIG. 9 in parallel to the high-reliable section record procedure illustrated in FIG. 2 and the warm-up section record section illustrated in FIG. 7.

At S400, the navigation ECU 20 determines whether the vehicle has moved into the high reliable section. More specifically, the navigation ECU 20 determines whether the present location of the subject vehicle has moved into any one of the high reliable sections stored in the information retainable storage. In one embodiment, the navigation ECU 20 specify a section that has the warm-up frequency greater than or equal to a predetermined threshold, based on information stored in the information retainable storage. The section that has the warm-up frequency greater than or equal to a predetermined threshold is also referred to herein as a warming-up expected section or the section where the vehicle performed the warming up. In one embodiment, the warming-up expected section is excluded from the high reliable section when it is determined at S400 whether the vehicle has moved into the high reliable section. In other words, it is determined whether the vehicle has moved into one of the high reliable sections from which the warming-up expected section is excluded.

When it is determined that the vehicle has not moved into the high reliable section, corresponding to “NO” at S400, the navigation ECU 20 repeatedly performs the process S400. In this case, the drive control of the engine and the motor is performed based on a predetermined rule under autonomous control of the HV controller 10. When it is determined that the vehicle has moved into the high reliable section, corresponding to “YES” at S400, the process proceeds to S402. At S402, from the information retainable storage, the navigation ECU 20 reads the SOC management schedule (corresponding to a travel schedule), which was made through setting a planed section to the high reliable section. In the above, the warming-up-expected section may be excluded from the high reliable section.

At S404, the navigation ECU 20 outputs control information to the HV controller 10 based on the SOC management schedule.

At S406, the navigation ECU 20 determines whether the vehicle has moved into the next section. More specifically, it is determined whether the present location of the vehicle is in the next section.

When it is determined that the vehicle has not moved into the next section, corresponding to “NO” at S406, the process returns to S404. In such a case, the navigation ECU 20 keeps on outputting the control information to the HV controller 10 based on the SOC management schedule read at S402.

When it is determined that the vehicle has moved into the next section, corresponding to “YES” at S406, the process proceeds to S408. At S408, the navigation ECU 20 determines whether the vehicle has moved to an outside of the high reliable section. More specifically, it is determined whether the present location of the vehicle is outside of the high reliable section.

When it is determined that the vehicle has not moved to an outside of the high reliable section, corresponding to “NO” at S408, the process returns to S404. In such a case, the navigation ECU 20 keeps on outputting the control information to the HV controller 10 based on the SOC management schedule read at S403.

When it is determined that the vehicle has moved to an outside of the high reliable section, corresponding to YES” at S408, the process proceeds to S410. At S410, the navigation ECU 20 determines whether the vehicle has arrived at the destination based on determining whether a signal indicating that the parking brake is in the ON state is inputted.

When the signal indicating that the parking brake is in the ON state is not inputted, corresponding to “NO” at S410, the process proceeds to S412. At S412, the navigation ECU 20 stops outputting the control information, and the process returns to S400. When the output of the control information is stopped, the drive control of the engine and the motor is performed based on a predetermined rule under autonomous control of the HV controller 10. When the vehicle moves again into a high reliable section, the above-described processes are performed again, and the drive control is performed based on the SOC management schedule that was made through setting a planed section to the high reliable section.

When the vehicle has arrived at the destination and when the signal indicating that the parking brake is in the ON state is inputted, the determination at S410 results in “YES”, and the drive control procedure is ended.

According to the above configuration, the number of times the vehicle has traveled a section of the travel route is calculated for every section of the traveled route. For every subsequent section, a travel probability that the hybrid vehicle travels the subsequent section after the present position section is calculated based on the number of times. A series of continuous sections included in the subsequent sections is specified, wherein each section in the specified series of continuous sections has the travel probability that is greater than or equal to a threshold. The specified series of continuous sections is recorded in the information retainable storage as a high reliable section. A travel schedule is made by using the high reliable section as a planned section. The drive control of the engine and the motor is performed based on the travel schedule. Due to the above manners, a section which a hybrid vehicle travels with a low probability is excluded from the high reliable section, and a section which the hybrid vehicle travels with a high probability is included in the high reliable section. Further, since the travel schedule is made through setting a planned section to the high reliable section, it is possible to improve fuel efficiency of the hybrid vehicle in the performing of the drive control of the engine and the motor based on the travel schedule.

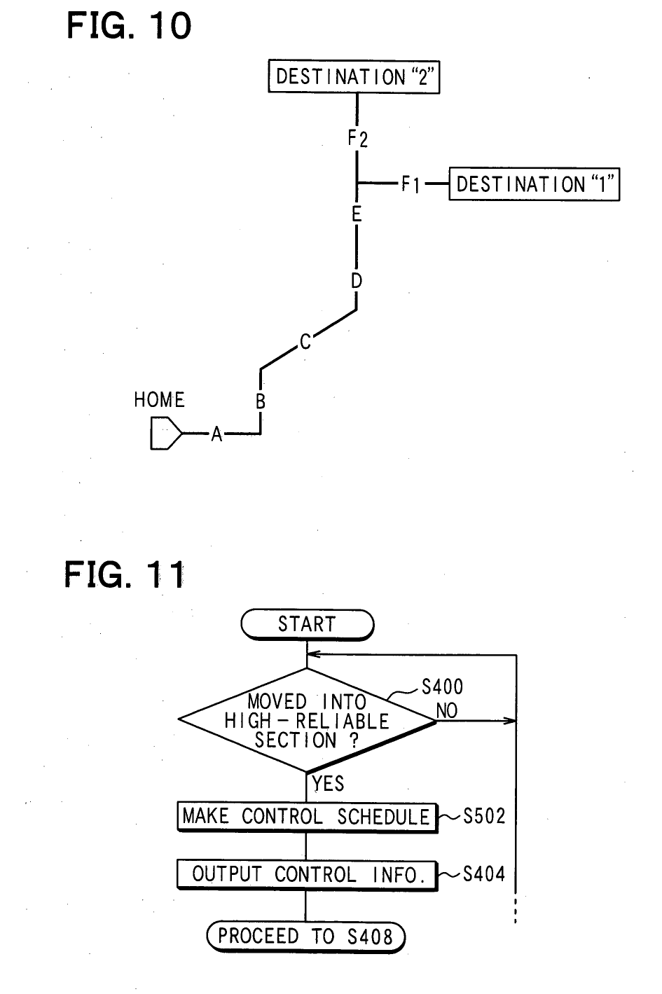

According to one embodiment, when a vehicle frequently goes to a particular destination by traveling the same route as is illustrated in FIGS. 3A to 3C, a high reliable section is set to sections close to the destination, and a travel schedule is made through setting a planned section to the high reliable section. When a vehicle frequently goes to a destination “1” and another destination “2” from home by traveling common sections “A” to “E” as is illustrated in FIG. 10, a high reliable section is set to the common sections “A” to “E”, and a travel schedule is made through setting a planned section to the high reliable section. When a vehicle frequently goes to a center of a next city with a lot of shops, a high reliable section becomes sections that are frequently passed on the way to the center of the next city, and a travel schedule is made through setting a planned section to the high reliable section. In one embodiment, since the travel schedule is made through setting a planned section to such high reliable sections, and since the drive control of the engine and the motor is performed based on the travel schedule, it is possible to improve fuel efficiency.

When there is a plurality of series of continuous sections each having a travel probability greater than or equal to a predetermined threshold, a high reliable section is set to one series of continues sections that is longest among the plurality of series of continuous sections, and a travel schedule is made through setting a planned section to the high reliable section. This manner improves fuel efficiency compares to a case in which the high reliable section is set to one series of continues sections whose length is smaller than the length of another series of continuous sections.

Since the warm-up section is a section where the warming up was performed, the drive control of the engine is expected to be performed in the warm-up section in another driving. Thus, if a travel schedule is such that the driving of the engine is not scheduled in the warm-up section, the drive control is likely not to follow the travel schedule in the warm-up section. In view of the above situation, according to one embodiment, the warming-up-expected section is excluded from the reliable section when it is determined whether the vehicle has moved into the high reliable section. Further, the drive control of the internal combustion engine and the motor is performed based on a travel schedule that is made through setting a planed section to the high reliable section from which the warming-up-expected section is excluded.

The above embodiments can be modified in various ways, examples of which are described below.

In the above embodiment, as shown in FIG. 2, a high reliable section is specified in the high reliable section record procedure, and then, the schedule planning process is performed through setting a planned section to the high reliable section. Further, as shown in FIG. 9, the planned section made in the high reliable section record procedure is read at S402, and the drive control of the engine and the motor is performed based on the travel schedule. Alternatively, the schedule planning process may not be performed in the high reliable section record procedure. Further, as shown in FIG. 11, a travel schedule may be made at S502 through setting a planned section to the high reliable section specified in the high reliable section record procedure, and the drive control of the engine and the motor may be performed based on the travel schedule. In the above, since the travel schedule is made after the vehicle has moved into the high reliable section, the performing of the drive control based on the travel schedule may be delayed. Thus, a travel schedule may be made in a section which the vehicle travels before the high reliable section.

In the above embodiment, when it is determined that the vehicle has moved into a high-reliable section, the navigation ECU 20 (i) reads a travel schedule, which was made through setting a planned section to the high-reliable section, from the information retainable storage and (ii) performs the drive control of the engine and the motor based on the travel schedule. Alternatively, the navigation ECU 20 may determine whether the vehicle is going to move into a high-reliable section. When it is determined that the vehicle is going to move into a high-reliable section, a display device (not shown) may display notification information before or after the vehicle moves into the high-reliable section. The notification information indicates that the drive control of the engine and the motor will be performed based on the travel schedule, which was made through setting a planned section to the high-reliable section. In displaying the notification information, the display device may further display information on the high-reliable section on a map. Alternatively, when different high reliable sections are found as a candidate of a planned section, the drive control apparatus may allow a user to specify which reliable section is set as the planned section, and may perform the drive control of the engine and the motor based on a travel schedule through setting the planned section to the specified high-reliable section.

In the above embodiment, the series of continuous sections, each of which has the travel probability greater than or equal to a predetermined threshold, includes the present position section. Further, the series of continuous sections including the present position section is stored in the information retainable storage as a high-reliable section. Alternatively, the series of continuous subsequent sections may not include the present position section and may be continuous sections located after the present position section, each section in the continuous sections having the travel probability greater than or equal to a predetermined threshold.

In the above embodiment, when it is determined at S400 whether the vehicle has moved into the high-reliable section, the warming-up-expected section is excluded from a high-reliable section. Alternatively, when it is determined whether the vehicle has moved into the high-reliable section, the warming-up-expected section may not be excluded from a high-reliable section.

According to the above embodiment, in the warm-up section record procedure, a warm-up frequency as to how often the warming up has been performed is calculated for every section, and is recorded in the information retainable medium. Then, in the drive control procedure, a section having the warm-up frequency greater than or equal to a predetermined threshold is specified as a warming-up-expected section. Alternatively, in the warm-up section record procedure, an engine stop time, which is a time when the engine is stopped, may be recorded together with the warm-up frequency of a section. Then, in the drive control procedure, when a length of period elapsed from the engine stop time is within a predetermined period of time, a section having the warm-up frequency greater than or equal to a predetermined threshold may not be specified as a warming-up expected section.

In the above embodiment, based on the warm-up determination information, it is determined whether the warming up is being performed. Alternatively, the determination as to whether the warming-up is being performed may be made without using the warm-up determination information. For example, the determination may be made in the following ways. A period of time elapsed from start of the engine of the vehicle is measured. Until the measured period of time exceeds a predetermined period of time, it is estimated that the warming up is being performed.

According to the above embodiment, in the warm-up section record procedure, information on a flag assigned to the present position section to indicate whether the present position section is a warm-up section is accumulatively recorded in the information retainable storage. Further, a warm-up frequency as to how often the warming up has been performed in the present position section for a predetermined period is calculated and stored in the information retainable storage. Then, in the drive control procedure, a section having the warm-up frequency greater than or equal to a threshold is specified as a warming-up-expected section. Alternatively, the information on a flag may be accumulatively recorded in the information retainable storage in the warm-up section store procedure, and further, a section with the flag ON may be specified as a warming-up-expected section in the warm-up section record procedure.

In the above embodiment; it is determined whether the warming up is being performed, based on the warm-up determination information obtained from the HV controller 10. In the above, the warm-up determination information may include three signals: a signal indicative of whether engine coolant temperature is greater than or equal to a predetermined temperature; a signal indicative of whether temperature of a battery for use in driving the motor is greater than or equal to a predetermined temperature; and a signal indicative of whether temperature of a catalyst in an exhaust gas purification apparatus is greater than or equal to a predetermined temperature. When the signal indicates that engine coolant temperature is greater than or equal to a predetermined temperature, and when the signal indicates that temperature of a catalyst in an exhaust gas purification apparatus is greater than or equal to a predetermined temperature, the present position section may be determined to be a warm-up section.

In the above embodiment, a drive control apparatus for a hybrid vehicle is configured to perform the drive control of an engine and a motor of the hybrid vehicle based on a travel schedule that was made through setting a planned section to a high-reliable section stored in a storage medium. The above-described configuration may be applied to a travel route prediction apparatus for a vehicle such as an engine powered vehicle, an electric vehicle, a fuel cell vehicle and the like. The travel route prediction apparatus predicts an expected travel route by setting the expected travel route to a high-reliable section stored in a storage medium. According to the above travel route prediction apparatus, it is possible to precisely predict an expected travel route even when a user does not set a destination. When the expected travel route is estimated in the above ways, it is possible to precisely predict vehicle actions in the high-reliable section, such as a turn direction of the vehicle at a next intersection, an interchange from which the vehicle exits from an express way and the like.

In the above embodiments and modifications, the navigation ECU 20 performing S100 to S109 and S200 can acts a high-reliable section record unit or means. The HV controller 10 and the navigation ECU 20 performing S400 to S404 and S502 can act as a drive control unit or means. The navigation ECU 20 performing S300 and S308 can act as a warm-up section record unit or means. The navigation ECU 20 can act as a scheduling unit or means by making a travel schedule through setting a planned section to a high reliable section stored in an information retainable storage. The navigation ECU 20 can act as a prediction unit by predicting an expected travel route by setting an expected travel route to a high reliable section stored in an information retainable storage. Using such a reliable section record unit and a such a scheduling unit, it is possible to provide a travel schedule making apparatus for a hybrid vehicle. The travel schedule making apparatus may be coupled with a storage medium that stores therein information on a plurality of sections of a traveled route that the hybrid vehicle has traveled. The travel schedule making apparatus includes the reliable section record unit and the scheduling unit. The hybrid vehicle equipped with the travel schedule making apparatus may performs the driving control of an engine and a motor based on a travel schedule made by the travel schedule making apparatus.

While the invention has been described above with reference to various embodiments thereof, it is to be understood that the invention is not limited to the above described embodiments and constructions. The invention is intended to cover various modifications and equivalent arrangements. In addition, while the various combinations and configurations described above are contemplated as embodying the invention, other combinations and configurations, including more, less or only a single element, are also contemplated as being within the scope of embodiments.

Further, each or any combination of procedures, processes, steps, or means explained in the above can be achieved as a software part or unit (e.g., subroutine) and/or a hardware part or unit (e.g., circuit or integrated circuit), including or not including a function of a related device; furthermore, the hardware part or unit can be constructed inside of a microcomputer.

What is claimed is:

1. A drive control apparatus (i) mounted to a hybrid vehicle using an internal combustion engine and a motor as a power source for traveling, (ii) configured to perform drive control of the internal combustion engine and the motor of the hybrid vehicle based on a travel schedule, and (iii) coupled with a storage medium, the drive control apparatus comprising:
a reliable section record unit configured to:
accumulatively record information on a plurality of sections of a traveled route that the hybrid vehicle has traveled;
accumulatively record, for every section of the traveled route, a number of times the hybrid vehicle has traveled the section;
identify a present position section and a plurality of subsequent sections from the sections of the traveled route, wherein the present position section is one section where the hybrid vehicle is located, wherein the subsequent sections include the present position section and another section where the hybrid vehicle is expected to travel after the present position section;
calculate, for every subsequent section, a travel probability that the hybrid vehicle travels the subsequent section, based on the number of times; and
record a high reliable section in the storage medium through setting the high reliable section to a series of continuous sections included in the subsequent sections, wherein each section in the series of continuous sections has the travel probability that is greater than or equal to a threshold; and
a drive control unit configured to:
determine whether the hybrid vehicle has moved into the high reliable section stored in the storage medium; and
perform the drive control of the internal combustion engine and the motor based on the travel schedule when it is determined that the hybrid vehicle has moved into the high reliable section, the travel schedule being made by using the high reliable section as a planned section.

2. The drive control apparatus according to claim 1, wherein:
when the subsequent sections include a plurality of series of continuous sections and when each section in the plurality of series of continuous sections has the travel probability greater than or equal to the threshold, the reliable section record unit records one series of continuous sections in the storage medium as the high reliable section, the one series of continuous sections being longest among the plurality of series of continuous sections.

3. The drive control apparatus according to claim 1, wherein:
the reliable section record unit makes the travel schedule by using the high reliable section stored in the storage medium as the planned section, and records the travel schedule in the storage medium; and
the drive control unit reads the travel-schedule from the storage medium and performs the drive control of the internal combustion engine and the motor based on the travel schedule.

4. The drive control apparatus according to claim 1, wherein:
the drive control unit makes the travel schedule by using the high reliable section stored in the storage medium as the planned section, and performs the drive control of the internal combustion engine and the motor based on the travel schedule.

5. The drive control apparatus according to claim 1, further comprising:
a warm-up section record unit configured to record, for each section of the traveled route, warm-up information in the storage medium, the warm-up information indicating whether the hybrid vehicle has performed warming-up in the section, the warm-up information further indicating a warming-up-expected section where the hybrid vehicle is expected to perform the warming-up,
wherein:
when the drive control unit determines that the hybrid vehicle has moved into the high reliable section, the drive control unit excludes the warming-up-expected section from the high reliable section based on the warm-up information; and
the drive control unit performs the drive control of the internal combustion engine and the motor based on the travel schedule, the travel schedule being made through setting the planned section to the high reliable section from which the warming-up-expected section is excluded.

6. A travel schedule making apparatus mounted to a hybrid vehicle, which uses an internal combustion engine and a motor as a power source for traveling and is configured to perform drive control of the internal combustion engine and the motor of the hybrid vehicle based on a travel schedule, the travel schedule making apparatus being coupled with a storage medium, the travel schedule making apparatus comprising:
a reliable section record unit configured to:
accumulatively record information on a plurality of sections of a traveled route that the hybrid vehicle has traveled;
accumulatively record, for every section of the traveled route, a number of times the hybrid vehicle has traveled the section;
identify a present position section and a plurality of subsequent sections from the sections of the traveled route, wherein the present position section is one section where the hybrid vehicle is located, wherein the subsequent sections include the present position section and another section where the hybrid vehicle is expected to travel after the present position section;
calculate, for every subsequent section, a travel probability that the hybrid vehicle travels the subsequent section, based on the number of times; and
record a high reliable section in the storage medium through setting the high reliable section to a series of continuous sections included in the subsequent sections, wherein each section in the series of continuous sections has the travel probability that is greater than or equal to a threshold; and
a scheduling unit that is configured to make the travel schedule through setting a planned section to the high reliable section stored in the storage medium.

7. A travel route prediction apparatus (i) mounted to a vehicle, (ii) configured to predict a expected travel route that the vehicle is expected to travel, and (iii) coupled with a storage medium, the travel route prediction apparatus comprising:
a reliable section record unit configured to:
accumulatively record information on a plurality of sections of a traveled route that the hybrid vehicle has traveled;
accumulatively record, for every section of the traveled route, a number of times the vehicle has traveled the section;
identify a present position section and a plurality of subsequent sections from the sections of the traveled route, wherein the present position section is one section where the hybrid vehicle is located, wherein the subsequent sections include the present position section and another section where the hybrid vehicle is expected to travel after the present position section;
calculate, for every subsequent section, a travel probability that the vehicle travels the subsequent section, based on the number of times; and
record a high reliable section in the storage medium through setting the high reliable section to a series of continuous sections included in the subsequent sections, wherein each section in the series of continuous sections has the travel probability that is greater than or equal to a threshold; and
a prediction unit that is configured to predict the expected travel route by setting the expected travel route to the high reliable section stored in the storage medium.
